(19) United States
(12) Patent Application Publication
(10) Pub. No.: US 2007/0168376 A1
(43) Pub. Date: Jul. 19, 2007

(54) Method of automatically including context related links

(75) Inventors: Steven Broeils Luitjens, Eindhoven (NL); Feng Li, Shanghai (CN); Gongming Wei, Shanghai (CN); Wenying You, Shanghai (CN); Darwin He, Shanghai (CN); Wilhelmus Franciscus Johannes Fontijn, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONIC, N.V., AA EINDHOVEN (NL)

(21) Appl. No.: 10/596,768

(22) PCT Filed: Dec. 23, 2004
(86) PCT No.: PCT/IB04/52913

§ 371 Date: Jun. 23, 2006

(30) Foreign Application Priority Data
Jan. 9, 2004 (EP) 04100044.9

(51) Int. Cl. G06F 7/00

(52) U.S. Cl. 707/102

(57) ABSTRACT

There is provided a method of automatically including one or more context related links in association with scene data content. The method is distinguished in that involves providing a recording apparatus including: (i) a data store for reading and/or writing data content; (ii) a sensor for sensing audio and/or visual subject matter from a scene and generating corresponding scene data content; (iii) identifying components for use in identifying a spatial location of the apparatus in proximity of the scene and/or an identity of the scene; (iv) a microprocessor for co-ordinating operation of the data store, the sensor and the identifying components. The method involves the steps of: (b) arranging for the data store to include link data susceptible to being invoked to associate one or more spatial locations and/or scene identities with corresponding linkable data content; (c) activating the apparatus in proximity of a desired scene and receiving audio and/or visual subject matter therefrom to generate corresponding desired scene data content; (d) using the identifying components to determine a spatial location of the apparatus in proximity of the desired scene and/or an identity of the desired scene; (e) identifying one or more links in the link data associated with the spatial location and/or identity determined in step (d) and recording them automatically together in the data store with at least one of the desired scene data content derived from step (c) and the spatial location and/or identity from step (d). The one or more links are concurrently and/or subsequently susceptible to being invoked to include corresponding linkable data content with the scene data to generate final composite data content.

The present invention relates to methods of automatically including context related links; in particular, but not exclusively, the invention relates to a method of automatically including context related links in image and/or audio data content to enable one or more images and/or audio samples in the data content to have associated therewith relevant subject matter. Moreover, the invention also relates to apparatus operable according to the method. Furthermore, the invention also relates to systems providing infrastructure suitable for enabling such apparatus to function according to the method.

It is well known to link together items of data content. The data content can include, for example, executable software, databases, audio data and image data. Such linking is implemented in well known contemporary networks, for example in the Internet, by way of Universal Resource Locators (URLs). When preparing subject matter for the Internet, for example constructing an Internet web-site linked to other web-sites via URLs, it is usual to enter such URLs in typed text form. Inclusion of URLs in text form, for example via a keyboard, is often inconvenient to implement when preparing data content rapidly.

In an article by Diomidis Spenellis published in a journal Pervasive Computer pp. 1536-1268, IEEE CS and IEEE ComSoc, there is described a Geotemporal Web System (GTWeb) operable to automatically convert raw data from a typical vacation trip into a lively Internet web-site. The GTWeb is arranged to exploit synergies arising from integrating various types of consumer-grade information appliances and publicly accessible databases, for example for purposes of presenting trip overviews, timelines, maps and annotated photographs. Constructing an Internet web-site using GTWeb is described in the article as being fully automatic and involves integrating photographs from a consumer-grade digital camera, a track log recorded from a handheld Global Positioning System (GPS) device and publicly accessible coastline, topography and gazetteer data. A GTWeb web-site thereby created is susceptible to being manually edited and includes a homepage. The homepage is also capable of being arranged to include links to timelines, maps and photograph galleries, for example presented in chronological order.

In the article, it is further disclosed that it is feasible to integrate digital compass information with other related collated data to provide directional details about each photograph or image recorded when constructing such a GTWeb web-site; such compass information is now available in some proprietary contemporary GPS receivers. Moreover, according to the article, such directional information is further susceptible to being used for detecting and recording camera rotation and inclination for each photograph or image. It is thereby feasible to annotate photographs with associated information pertaining to three-angle rotational and lens setting metadata to mark interesting features or create image-based hyperlinks.

The inventors have appreciated that contemporary digital cameras are increasingly employed by their owners for recording images of venues they have visited; for example, digital “snap shots” of sites such as the Eiffel Tower in Paris. Such recorded images are often downloaded by users from their digital cameras into computing apparatus, for example portable lap-top computers, for compilation into travel logs for subsequent personal viewing and/or presentation to third parties. The inventor has envisaged that it is presently feasible for such users when annotating their recorded images to include links to associated stored subject data pertinent to the images. For example, a picture of the Eiffel Tower is beneficially annotated with links to Internet sites providing a historical description of the International Exhibition of Paris of 1889 commemorating the centenary of the French Revolution. In practice, such annotation is seldom undertaken by users so that tour snapshot images are often difficult to fully appreciate and/or present to third parties many months or years after the tour occurred.

Whereas the inventors have appreciated that it is feasible to integrate digital image camera information with URL link information and GPS positional information to provide a composite travel record with relevant links included, the inventors have also appreciated that such integration is presently unwieldy to achieve conveniently in practice and have therefore devised a convenient method of automatically including context related links in data content including one or more images or photographs.

A first object of the invention is to provide a convenient method of automatically including context related data links in recorded data content.

A second object of the invention is to provide an advanced apparatus, for example akin to a contemporary digital camera, susceptible to providing its users with more comprehensive records of their trip or journeys.

According to a first aspect of the present invention, there is provided a method of automatically including one or more context related links in association with scene data content, characterized in that the method includes the steps of:

(a) providing a recording apparatus including:

(i) data storing means for reading and/or writing data content;

(ii) sensing means for sensing audio and/or visual subject matter from a scene and generating corresponding scene data content;

(iii) identifying means for use in identifying a spatial location of the apparatus in proximity of the scene and/or an identity of the scene;

(iv) computing means for co-ordinating operation of the data storing means, the sensing means and the identifying means;

(b) arranging for the data storing means to include link data susceptible to being invoked to associate one or more spatial locations and/or scene identities with corresponding linkable data content;

(c) activating the apparatus in proximity of a desired scene and receiving audio and/or visual subject matter therefrom to generate corresponding desired scene data content;

(d) using the identifying means to determine a spatial location of the apparatus in proximity of the desired scene and/or an identity of the desired scene;

(e) identifying one or more links in the link data associated with the spatial location and/or identity determined in step (d) and recording them automatically together in the storing means with at least one of the desired scene data content derived from step (c) and the spatial location and/or identity from step (d),

wherein the one or more links are concurrently and/or subsequently susceptible to being invoked to include corresponding linkable data content with the scene data to generate final composite data content.

The invention is of advantage in that it is capable of providing a more convenient approach to incorporating context related data links.

Preferably, in step (d) of the method, the identifying means is arranged to determine the spatial location of the apparatus in proximity of the desired scene and/or the identity of the desired scene by employing at least one of:

(i) a GPS satellite-derived reference;

ii) an identification provided from one or more remotely communicating devices included within the desired scene, the devices being arranged to impart information regarding the nature of the scene to the apparatus; and

(iii) by image and/or audio analysis of the desired scene data content by correlating and/or associating the desired scene data with scene-identification reference data.

Use of one or more of such options, for example by data merging, is of advantage in that reliability of automatic inclusion of the data links can thereby be improved.

Preferably, in the method, the one or more links automatically included with the scene data content are susceptible to being at least one of:

(i) dormant and susceptible to being activated on subsequent user demand;

(ii) active at user demand and susceptible to being rendered dormant on subsequent user demand.

Such prioritizing of automatically inserted context related links is of advantage in that it is capable of assisting the user of the apparatus to evaluate scenes of particular interest or relevance.

Preferably, in the method, the one or more links automatically and/or on user demand included with the scene data content are susceptible to being subsequently deleted, for example when not required for generating the composite data. Deletion of unwanted links is of advantage when removing links that the user of the apparatus judges to be unsuitable and/or undesirable.

Preferably, in the method, at least one of the link data and its associated linkable data content are provided to the apparatus in at least partly encrypted form, the apparatus being operable to decrypt at least a part of the encrypted link data and its associated link data content using one or more decryption keys. Use of encryption is of benefit in that it provides a mechanism by which suppliers of the link data and linkable data content can receive payment for their work in compiling such data. More preferably, in the method, the one or more decryption keys are provided to the apparatus in return for corresponding consideration, for example payment.

Preferably, in the method, the data storing means is operable to receive the link data by at least one of:

(i) coupling the apparatus to a communication network having available therein the link data; and

(ii) introducing a data carrier to the storing means, the carrier including at least the link data recorded thereon.

If required, a combination of these two approaches (i) and (ii) can be adopted such that more standard link data and linkable data content is provided on a standard data carrier such as a small format optical disc with specialist supplementary being downloadable from a communication network, for example the Internet.

Preferably, in the method, the data storing means comprises at least one of:

(a) one or more optical data carriers;

(b) one or more magnetic hard disc data carriers; and

(c) one or more solid state memory devices,

for recording thereon of one or more of the link data, the linkable data content, the desired scene data and the composite data content. More preferably, the storing means is disposed such that at least one of the data carriers is externally accessible to the apparatus for introducing at least one of the link data and the linkable data content to the apparatus. For example, such features render the apparatus capable of receiving external data issued on data carriers from a variety of data vendors. More preferably, in view of the apparatus being optionally a compact item comparable in size to a compact photographic camera, the data carrier is a small format optical data storage (SFFO) disc.

Preferably, in the method, the link data includes at least one universal resource locator (URL) susceptible to being invoked to access linkable data content via a communication network, for example the Internet. The use of such URL's renders the apparatus more readily useable with contemporary data communication networks and their data repositories which utilize URL's for searching and access.

Preferably, in the method:

(i) the link data and its associated linkable data are provided to the apparatus on an externally accessible first data carrier; and

(ii) the one or more links in the link data associated with the spatial location in step (e) together with the desired scene data content on an internally retained second data carrier.

More preferably, the first data carrier is a vendor-supplied item whose link data and its associated linkable data content are at least partly in encrypted form and susceptible to being accessed by supplying one of more corresponding decryption keys to the apparatus, such decryption keys being obtainable for example in return for payment or other consideration. Yet more preferably, in the method, the first data carrier includes encrypted link data and/or linkable data content which is encrypted in a plurality of degrees so that progressive access to the link data and/or linkable data content is achievable corresponding to progressive acquisition of decryption keys.

Beneficially, in the method, the linkable data content includes at least one of: supplementary pictures, movies, sound, text and web-sites.

According to a second aspect of the present invention, there is provided an apparatus operable to include automatically one or more context related links in association with scene data content, characterized in that the apparatus includes:

(i) data storing means for reading and/or writing data content;

(ii) sensing means for sensing audio and/or visual subject matter from a scene and generating corresponding scene data content;

(iii) identifying means for use in identifying a spatial location of the apparatus in proximity of the scene and/or an identity of the scene;

(iv) computing means for co-ordinating operation of the data storing means, the sensing means and the identifying means; wherein:

(a) the data storing means is arranged to include link data susceptible to being invoked to associate one or more spatial locations with corresponding linkable data content;

(b) the apparatus is operable when in proximity of a desired scene to receive audio and/or visual subject matter therefrom to generate corresponding desired scene data content;

(c) the identifying means is operable to determine a spatial location of the apparatus in proximity of the desired scene and/or the identity of the desired scene;

(d) the computing means is operable to identify one or more links in the link data associated with the spatial location and/or the identity of the desired scene determined by the identifying means and to record them automatically together in the storing means with at least one of the desired scene data content derived from sensing means and the spatial location and/or the identity derived from the identifying means,

wherein the one or more links are concurrently and/or subsequently susceptible to being invoked to include corresponding linkable data content with the scene data to generate final composite data content.

Preferably, in the apparatus, the identifying means is operable to determine the spatial location of the apparatus in proximity of the desired scene and/or the identity of the desired scene by employing at least one of:

(i) a GPS satellite-derived reference;

(ii) an identification provided from one or more remotely communicating devices included within the desired scene, the devices being arranged to impart information regarding the nature of the scene to the apparatus; and

(iii) by image and/or audio analysis of the desired scene data content by correlating and/or associating the desired scene data with scene-identification reference data.

Preferably, in the apparatus, the one or more links automatically included with the scene data content are susceptible to being at least one of:

(i) dormant and susceptible to being activated on subsequent user demand;

(ii) active at user demand and susceptible to being rendered dormant on subsequent user demand.

More preferably, in the apparatus, the one or more links automatically and/or on user demand included with the scene data content are susceptible to being subsequently deleted, for example when not required for generating the composite data.

Preferably, in the apparatus, at least one of the link data and its associated linkable data content are provided to the apparatus in at least partly encrypted form, the apparatus being operable to decrypt at least a part of the encrypted link data and its associated link data content using one or more decryption keys.

Preferably, in the apparatus, the one or more decryption keys are provided to the apparatus in return for corresponding consideration, for example payment. Preferably, in the apparatus, the data storing means is operable to receive the link data by at least one of:

(i) coupling the apparatus to a communication network having available therein the link data; and

(ii) introducing a data carrier to the storing means, the carrier including at least the link data recorded thereon.

Preferably, in the apparatus, the data storing means comprises at least one of:

(a) one or more optical data carriers;

(b) one or more magnetic hard disc data carriers; and

(c) one or more solid state memory devices,

for recording thereon of one or more of the link data, the linkable data content, the desired scene data and the composite data content. More preferably, in the apparatus, the storing means is disposed such that at least one of the data carriers is externally accessible to the apparatus for introducing at least one of the link data and the linkable data content to the apparatus. Most preferably, the data carrier is a small format optical data storage (SFFO) disc.

Preferably, in the apparatus:

(i) the link data and its associated linkable data are provided to the apparatus on an externally accessible first data carrier; and

(ii) the one or more links in the link data associated with the spatial location in step (e) together with the desired scene data content on an internally retained second data carrier.

Preferably, the first data carrier is a vendor-supplied item whose link data and its associated linkable data content are at least partly in encrypted form and susceptible to being accessed by supplying one of more corresponding decryption keys to the apparatus, such decryption keys being obtainable for example in return for payment or other consideration. More preferably, the first data carrier includes encrypted link data and/or linkable data content which is encrypted in a plurality of degrees so that progressive access to the link data and/or linkable data content is achievable corresponding to progressive acquisition of decryption keys.

According to a third aspect of the present invention, there is provided infrastructure or providing a position reference and/or a scene identification in proximity of the desired scene to the identifying means in the method according to the first aspect of the invention.

According to a fourth aspect of the present invention, there is provided infrastructure for providing a position reference and/or a scene identification in proximity of the desired scene and/or an identification of the desired scene for use with the apparatus according to second aspect of the invention.

It will be appreciated that features of the invention are susceptible to being combined in any combination without departing from the scope of the invention.

Embodiments of the invention will now be described, by way of example only, with reference to the following diagrams wherein:

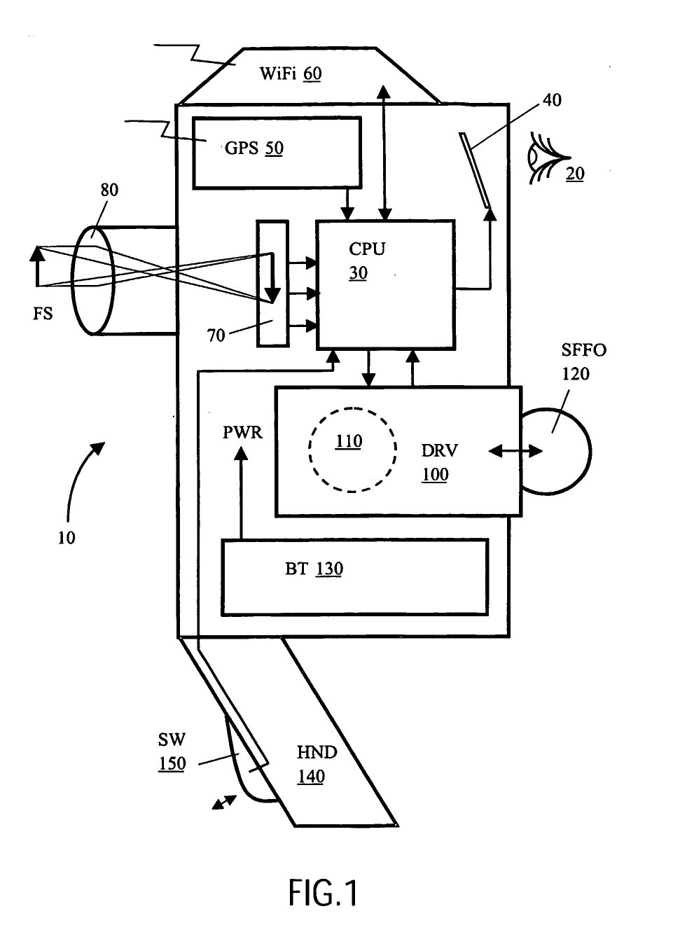

FIG. 1 is an illustration of an apparatus suitable for use with the method of the invention;

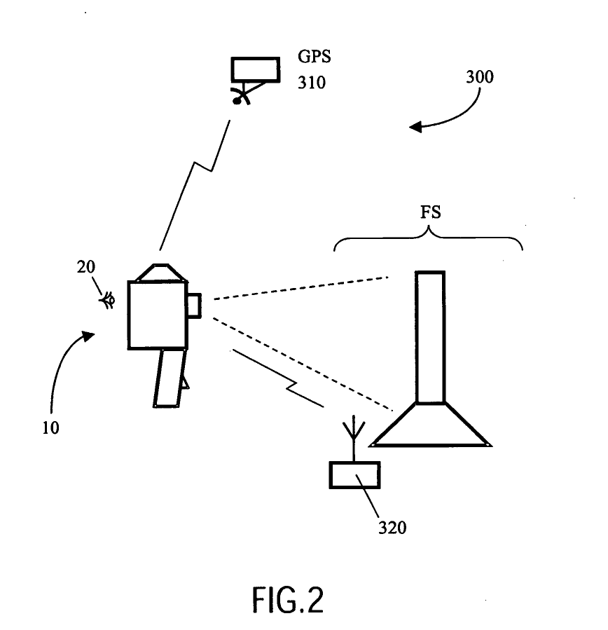

FIG. 2 is an illustration of an exemplary configuration in which the apparatus is employed in use;

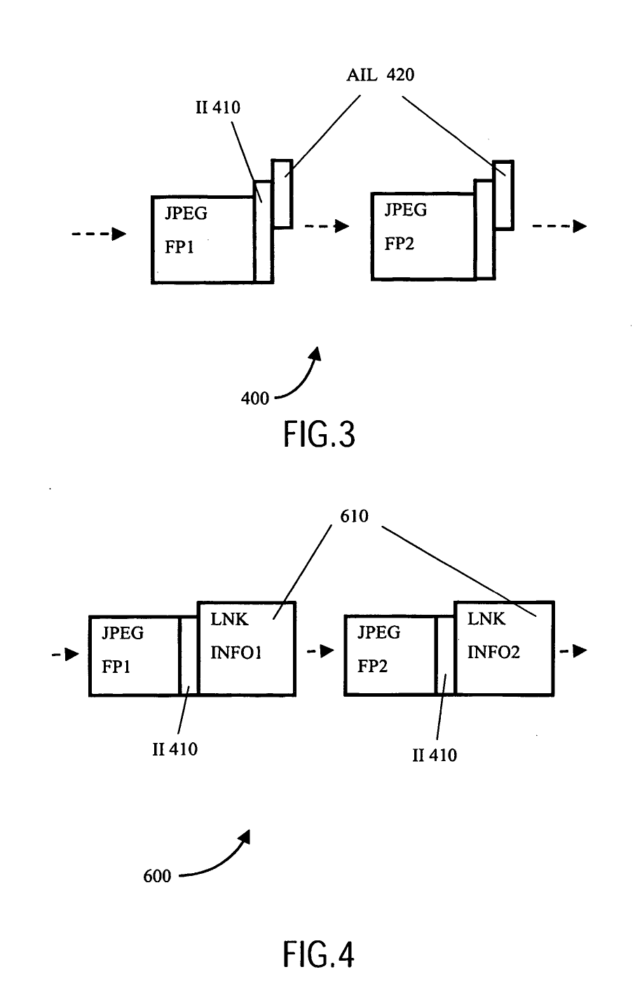

FIG. 3 is an illustration of a sequence of images in which the apparatus of FIG. 1 is capable of automatically inserting associated links; and

FIG. 4 is an illustration of a sequence of images with subject matter inserted as identified by the automatically-inserted links as depicted in FIG. 3.

The present invention is concerned in at least one of its embodiments with a concept of automatically inserting links, for example Universal Resource Locators (URL), in one or more photographs and/or video recordings and/or audio recordings. Moreover, the links are executable to identify supplementary information on subsequent viewing or presentation of the one or more photographs and/or video recordings and/or audio recordings. The supplementary information preferably includes at least one of supplementary pictures, movies, sound, text and other web-sites pertinent to one or more locations visited by a user and at which the user has employed his/her camera to acquire images. Conveniently, the supplementary information is provided to the user on a compact data carrier, for example a small-format optical data storage disc (SFFO) also known as a “Portable Blue” disc. Optionally, the user has paid for the storage disc in advance. Alternatively, the storage disc is issued free of charge and the user is obliged to pay a fee to access data content recorded on the storage disc.

The data carrier is susceptible to having recorded thereon a substantial amount of data to which the user can obtain various degrees of access rights in return for corresponding payment of fees to a supplier of the compact data carrier. In the case of the user being a tourist using an associated digital camera at various tourist venues to record images therefrom, the compact data carrier can be conveniently issued from vendors such as tourist information shops, travel agents and libraries.

A problem with the aforementioned GTWeb is that information required for annotating recorded images accessible by way of links, for example URL's, is scattered. Moreover, information identified by the links is not always entirely relevant and hence will appear inappropriate and/or confusing in a final compilation for viewing by third parties. Furthermore, identifying appropriate links and their associated data content is potentially time consuming and laborious unless taken into account beforehand by the user. Thus, although the aforesaid GTWeb may seem a beneficial arrangement, it is impractical for many potential users.

The inventors have appreciated that such impracticability is addressable by including one or more links, for example one or more URLs, which are automatically obtained and inserted in one or more appropriate positions in a recorded image sequence file. Beneficially, such automatic insertion is triggered by location identifying devices, for example wireless local area networks (LANS) and/or wireless wide area networks (WANS) devices, triggering a user's apparatus to include one or more such links. Alternatively, or additionally, automatic inclusion of one or more links is susceptible to being triggered from a GPS reference of the user's apparatus. As a further option, the user's apparatus is provided with image recognition facilities so that the user directing their apparatus towards a scene results in the apparatus correlating an image received from the scene and comparing and/or associating it with one or more reference images; where correlation and/or association of an observed image with a reference image occurs, the user's apparatus is arranged to include automatically a relevant link, for example a pertinent URL.

When the user directs their apparatus towards a given scene, the user is also capable of inserting one or more links on demand, for example by depressing a “link insert” switch whilst directing their apparatus towards the scene. When the user elects not to request one or more links to be inserted on demand, the apparatus automatically inserts links which can be either confirmed later, for example on subsequent replay and/or inspection of recorded image subject matter, or deleted later if not required. Such automatic insertion of links renders such apparatus considerably easier to use in practice than presently known schemes for link insertion, for example the GTWeb as elucidated in the foregoing.

In order to further elucidate embodiments of the invention, subject matter of FIGS. 1 to 4 will now be described.

In FIG. 1, there is shown a camera apparatus indicated generally by 10. The apparatus 10 is suitable for use in implementing the method of automatically including context related links according to the present invention. In order to implement the method, the apparatus 10 is operable to record one or more images and/or associated audio content of a scene (FS) represented by an upright arrow, for example a famous scene such as the Eiffel Tower in Paris. The apparatus 10 includes an exterior protective casing, for example fabricated from injection moulded plastics material, into which is mounted a microprocessor (CPU) 30 coupled to a miniature liquid crystal display (LCD) 40 for presenting images and other apparatus operating information to a user 20. Moreover, the apparatus 10 further comprises a global positioning system (GPS) receiver 50 for use in determining in operation a spatial position reference for the apparatus 10; the receiver 50 is coupled to the microprocessor 30 for providing position reference co-ordinates thereto. Furthermore, the apparatus 10 also includes a wireless interface 60 connected to the microprocessor 30 for enabling the microprocessor 30 to communicate with one or more of wireless local area networks (LANS), wireless side area networks (WANS) as in mobile telephones, and radio frequency tag type devices (RFID) such as Blu-Tooth compatible devices.

For making one or more recordings of images of scenes towards which the apparatus 10 is directed in use, the apparatus 10 comprises a pixel array optical sensor 70, for example a pixel matrix charge couple array device (CCD), as employed in contemporary digital cameras. Associated with the optical sensor 70 is an optical imaging assembly 80, for example comprising one or more lenses optionally arranged in a variable zoom magnifying configuration for projecting a real image of the scene (FS) onto the sensor 70. Optionally, the assembly 80 also includes an auto-iris exposure control feature and/or auto-focus control operable in conjunction with the microprocessor 30. The apparatus 10 further comprises an internal memory storage device (DRV) 100, for example a compact optical disc storage drive susceptible to utilizing small-format optical memory disc data carriers (SFFO). Preferably, the storage device 100 is an optical disc drive utilizing substantially blue-wavelength radiation for interrogating aforementioned small format optical disc data carriers, as in a proprietary “Portable-Blu” type of optical disc storage medium developed by Philips Corporation in the Netherlands. The drive 100 is preferably arranged to include a small-format optical disc data carrier 110 which is permanently retained within the drive 100 together with an arrangement for accommodating an externally-accessible removable data carrier 120, for example a small-format optical disc data carrier (SFFO). Additionally, the apparatus 10 includes an integral source of power (BT) 130, for example a rechargeable lithium battery and/or nickel-metal halide battery for providing electrical power (PWR) to electronic sub-components of the apparatus 10, for example the microprocessor (CPU) 30 and the drive (DRV) 100. Finally, the apparatus 10 includes as part of its exterior enclosure a hand-grip 140 suitable for the user 20 to hold when directing the optical assembly 80 of the apparatus 10 towards the scene (FS). Moreover, the hand-grip 140 includes a user-actuable switch array 150 connected to the microprocessor 30. The switch array 150 includes several switch buttons for adjusting optical zoom provided by the optical assembly 80, for indicating to the microprocessor 30 that one or more images and/or video image sequences are to be recorded in the drive 100, and for electing on demand that one or more links relevant to the scene (FS) are to be recorded in the drive 100, in particular on the data carrier 10 as will be elucidated in further detail later.

Operation of the apparatus 10 illustrated in FIG. 1 will now be described in overview with reference also to FIG. 2.

Prior to making a trip, the user 20 visits a tourist information retailer and/or a travel agent and purchases or otherwise acquires a small format optical disc (SFFO), for example the disc 120. There is recorded on the disc 120 link data, for example Universal Resource Locators (URL's), and/or data content such as maps, images, photographs. video clips, and factual data such as narrative pertaining to one or more historical sites. The disc 120 is preferably a standard manufactured item which includes a wide variety of data relating to a potentially large range of possible tourist venues, for example ranging from Europe, Africa, North America, South America, Asia to mention a few. Moreover, the data recorded on the disc 120 is preferably, at least in part, in an encrypted form using one or more private encryption keys available only to the vendor of the data recorded on the disc 120. Furthermore, for example in return for payment or other form of consideration, the vendor also provides one or more public decryption keys complementary to the one or more private encryption keys respectively, the one or more public decryption keys not being user derivable from the one or more private keys and vice versa. Thus, the data recorded on the disc 120 is subject to private-public key encryption and associated decryption.

Thus, the disc 120 is preferably issued substantially free of cost and the user 20 pays a fee to receive one or more public decryption keys for selectively accessing user-data on the disc 120. The public decryption keys are susceptible to being used by the user 20 for accessing the user-data on the disc 120 in different ways. For example, one example public decryption key is employable by the user 20 for accessing map data recorded in encrypted form on the disc 120. Another example public decryption key is employable for decrypting and thereby accessing images of various historical and/or tourist sites recorded in encrypted form on the disc 120, for example photographic images of such venues shot in optimal sunlight conditions and from an especially advantageous and/or aesthetically pleasing viewing directions, for example from normally-inaccessible viewing galleries, towers or balconies. Yet another example public decryption key is employable for decrypting and hence accessing encrypted data content on the disc 120 pertaining to a specific field of interest, for example church venues throughout various geographical regions especially with regard to musical pipe organs at these venues and their associated stop specifications. Such specific fields of interest are optionally geographically limited, for example church venues in Europe, and can be further limited on other criteria such as whether or not the church venues are classified as being cathedrals. Thus, a degree to which the user 20 is able to gain access to encrypted data on the disc 120 is determined by one or more decryption keys provided to the user 20 from the vendor of the disc 120 in return for payment from the user 20 to the vendor. Optionally, the disc 120 also includes data content which are freely available to the user 20 without the need for obtaining access to one or more public decryption keys. Such freely available data content is executable on the microprocessor 30 to present on the display 40 to the user 20 one or more advertisements informing the user 20 of the potential availability of further data content without the user 20 needing to be aware that the advertised data content is already included in the disc 120 but in encrypted form.

If required, the one or more public keys for decrypting data content on the disc 120 can be time limited in effect, for example subject to the payment of annuities and/or annual subscriptions. Alternatively, the one or more keys received in return for payment can be of temporally unlimited duration, namely a “once-off” payment where the public key provided promptly destroys itself after decrypting content on the disc 120 to enhance security. Preferably, the one or more public decryption keys are communicated to the apparatus 10 via short-distance radio communication through the wireless interface 60, for example at the aforementioned tourist information office. Alternatively, or additionally, the one or more public decryption keys are susceptible to being communicated to the apparatus 10 via a public communication network such the Internet by coupling the apparatus 10 to such a network, for example by way of a telephone modem (not shown). The one or more public decryption passwords received at the apparatus 10 are preferably stored in solid-state non-volatile memory of the microprocessor (CPU) 30 and/or in the disc drive 100, for example on the disc 110.

After purchasing, or receiving as a free hand-out, the disc 120 and purchasing one or more corresponding public decryption keys, the user 20 inserts the disc 120 into the drive (DRV) 100 and then departs on a trip to visit a scene (FS), for example a famous site, as indicated in FIG. 2 generally by 300. When in view of the scene (FS) with the apparatus 10 directed theretowards, the user 20 depresses at least one of the switches (SW) 150 to cause an image of the scene (FS) to be projected by the optical assembly 80 onto the optical sensor 70. The sensor 70 is operable to output image pixel data to the microprocessor (CPU) 30 which then subsequently presents to the user 20 on the display 40 an image corresponding to that projected onto the sensor 70. If the user 20 is desirous to record the image presented on the display 40, the user 20 presses another of the switches 150 in response to which the microprocessor 30 is operable to record data content corresponding to an image projected onto the sensor 70 onto the disc 110; the data content is preferably in the form of one or more digital pixel images and/or a video sequence of such images. Moreover, in order to provide for efficient use of storage capacity in the disc 10, the one or more images and/or the video sequence are recorded on the disc 110 in compact encoded form, for example by way of contemporary MPEG and/or JPEG encoding. Whilst recording data provided from the optical sensor 70 onto the disc 10, the microprocessor 30 is also operable to determine by way of the receiver (GPS) 50 a corresponding geographical satellite GPS reference for the apparatus 10 from a plurality of satellites denoted by 310 in FIG. 2; preferably, such a reference also includes compass orientation information indicative of a viewing direction of the apparatus 10. The apparatus 10 is operable to store on the disc 110 not only image data from the sensor 70 but also the GPS reference wherein contemporary GPS position sensing is susceptible to providing a positional accuracy to within a few tens of meters of actual position of the apparatus 10; the apparatus 10 is optionally arranged to record such GPS position reference information together with data derived from the optical sensor 70. The viewing direction of the apparatus may also be stored on the disc.

The apparatus 10 via its wireless interface 60 is also receptive to transmissions from a local radio transponder, for example to a transponder 320 located unobtrusively within the scene (FS), e.g. objects in the scene may incorporate RF tags. Most conveniently, the transponder 320 is a short-distance communication device akin to a proprietary Blue Tooth RFID tag; alternatively, the transponder 320 can be a node of a WAN or LAN, for example a node coupled in communication with a public network such as the Internet. The transponder 320 is arranged to radiate radio frequency radiation therefrom modulated with information useable by the apparatus 10 to identify the identity of the scene (FS). When such a transponder 320 is present, the apparatus 10 is optionally operable to record such identity information on the disc 10 together with associated image data from the sensor 70; such recording will be elucidated in more detail later.

As a further option, the apparatus 10 is susceptible to performing a degree of image analysis. When the user 20 has paid for one or more decryption keys enabling access to private-key encrypted data content on the disc 120, one or more of such keys preferably provides access to standard reference images of the scene (FS), the reference images being of a form suitable for correlation and/or association with images projected onto the sensor 70 for image recognition purposes. Such image recognition is preferably performed in software executing on the microprocessor (CPU) 30.

Thus, the apparatus 10 is capable of merging identification data from at least one of the GPS receiver 50, the transponder 320 via the wireless receiver 60, a time reference within the apparatus 10 and image recognition correlation and/or association to obtain a greater certainty of the nature of the scene (FS). Preferably, at least part of this identification data is recorded on the disc 110. It is of benefit that identification of the scene (FS) occurs through a plurality of identifiers because reliability of operation of the apparatus 10 is thereby enhanced, for example in a situation where GPS is unavailable, unreliable or inaccurate; reliability of automated context-related link insertion is thereby enhanced.

Each time image data corresponding to one of more images of the scene (FS) derived from the sensor 70 is recorded on the disc 110, the microprocessor 30 is operable to use the identification of the site to identify one or more corresponding links, for example URL's, provided on the disc 120, and automatically insert such links in image data derived from the sensor 70 recorded on the disc 110. When the user 20 has not pressed a switch amongst the switches 150 for electing to insert one or more links on demand, the apparatus 10 automatically copies corresponding identified link data from the disc 120 to the disc 110 for inclusion with the recorded image data, preferably such that the links are dormant, for example for subsequent confirmation when the recorded image data on the disc 110 is subsequently reviewed. Conversely, when the user 20 presses a switch for electing to insert one or links on demand, the apparatus 10 is operable to include the link data in a confirmed, namely non-dormant manner, into the recorded image data on the disc 110. It will be appreciated that the user 20 is optionally selectively able to delete confirmed link data recorded on the disc 110 at subsequent review.

The aforementioned link data is susceptible of being of several mutually different types. A first type of link data provides one or more links to data available, for example in encrypted form, locally on the disc 120. A second type of link data provides one or more links available through a public network such as the Internet. However, the disc 120 is preferably arranged to include links of both types. Optionally, links of certain categories can be in encrypted form on the disc 120 and accessible to the user 20 on payment of a fee to receive one or more appropriate public decryption keys. In a case where access to certain encrypted links has not been obtained beforehand, such encrypted links are either not included in data recorded on the disc 110 in association with image data from the sensor 70, or are recorded on the disc 110 in encrypted form for subsequently retrospectively accessing on payment of a fee for associated public decryption keys; such inclusion of links is preferably user selectable when setting modes of operation of the apparatus 10.

Referring next to FIG. 4, there is illustrated a format for image data and associated link data recorded on the disc 110, the format being indicated generally by 400. Image data from the optical sensor 70 processed in the microprocessor 30 is preferably recorded in encoded form giving rise to data compression, for example as in contemporary JPEG image encoding and/or MPEG image encoding. Thus, encoding image data corresponding to the first and second images are recorded in the format as encoded compressed data fields JEPG FP1 and JPEG FP2. Associated with each of the data fields is associated reference data fields, for example a data field II 410 is included together with the data field JPEG FP1. Moreover, the format 400 also includes the aforementioned automatically-inserted link data AIL 420 together with an associated indicator of whether or not the link data has been inserted on demand by the user 20.

After completion of recording of the sequence of image data on the disc 110, the user 20 can set the apparatus 10, for example by way of the switches 150, to process data in the format 400 in an expanded format as illustrated in FIG. 4, the expanded format being indicated generally by 600. Where the link data AIL 420 is expanded, it gives rise to expanded link information 610, for example LNK INFO1 and LNK INFO2 associated with encoded compressed image data JPEG FP1 and JPEG FP2 respectively. When the links recorded automatically and/or on demand on the disc 110 only link to data content recorded on the disc 120, the apparatus 10 is capable of performing an expansion of link data as illustrated in FIGS. 3 and 4 without access to external networks, for example to the Internet. However, where the link data recorded also refers to data content external to the apparatus 10, either the apparatus 10 is coupled to repositories of such data external content, or reformatting as illustrated in FIGS. 3 and 4 is performed externally to the apparatus 10, for example by downloading data therefrom to a lap-top computer. Preferably, the drive 100 can be arranged so that the disc 120 is susceptible to being removed and another corresponding type of writable optical disc inserted into the drive 100 for receiving data copied from the disc 110, for example for subsequent archiving to prevent the disc 110 from becoming saturated with data. Thus, the drive 100 is preferable a read/write optical drive capable of not only reading data from one or more of the discs 110, 120 but also writing on one or more other such discs.

As described in the foregoing, the link data is susceptible to being confirmed or deleted by the user 20 on subsequent review of one or more images and/or video sequences recorded on the disc 110. Moreover, the data links can relate to subject matter including, but not limited thereto, further images, audio data, factual data and diagrammatic data such as maps and sketches. Thus, it is feasible for the user 20 employing the apparatus 10 and having purchased a copy of the disc 120 to travel on holiday, for example a weekend trip to Paris, to record a sequence on images from principal tourist sites there, whilst appropriately operating the switches 150 of the apparatus 10. On return from the trip, the user 20 is able to either invoke, delete or maintain dormant the various links which have been automatically inserted and/or inserted on user-demand to create an animated audio/visual presentation with various background data, for example historical data pertaining to royalty, artists, architects, benefactors as well as aerial views of such sites and related maps. Moreover, by selecting image and link data content selection parameters at commencement of presented the recorded images in expanded form, it is possible for the user 20 to present an account of the trip to Paris with particular emphasis on particular aspects of the trip, for example gothic church architecture on the one hand or French impressionist artists on the other hand.

It will be appreciated that embodiments of the invention described in the foregoing are susceptible to being modified without departing from the scope of the invention as defined by the appended claims.

Preferably, the battery 130 is rechargeable by mounting the apparatus 10 on a battery charging device which is inductively coupled to a charging circuit connected to the battery 130, for example by way of a high-frequency air-cored transformer coupling.

Where the wireless interface 60 is capable of supplying data content rapidly in response to the apparatus 10 invoking automatically-inserted links, expansion of recorded image data on the disc 110 with associated linked material is capable of being implemented in real time during acquisition of the one or more images presented to the optical sensor 70. If required, automatically inserted links can be dormant in the one or more images on the disc 110 so as to provide for interactive viewing of the one or more images with subject matter associated with automatically inserted links being invocable on subsequent demand of a viewer of the one or more recorded images, for example by way of an interactive search through the one or more recorded images via a plurality of searching routes, for example chronologically, by way of subject matter and/or by other criteria.

The apparatus 10 is also susceptible to including a microphone for audio content recording on the disc 110 in a similar manner to image recording from the optical sensor 70. Optionally, in a similar manner to image recognition undertaken by the microprocessor 30 with regard to reference images provided on the disc 120, such audio content is susceptible to being analyzed for particular oral expressions such as “the Eiffel Tower”. When, for example, a geographical reference provided by the GPS receiver 50 correlates and/or is otherwise capable of being closely associated with such oral expressions identified by the microprocessor 30, the apparatus 10 is susceptible to being configured to insert associated relevant link data when recording on the disc 110, the oral expressions thereby providing confirmation to the GPS reference and thereby providing a higher degree of certainty that the automatically inserted context-related links are relevant.

Optionally, the disc 120 can be arranged to be a read/write optical disc and provided with a blank data field for receiving encoded compressed image and/or audio data provided by the microprocessor 30 from its associated optical sensor 70 and/or audio sensor (not shown); moreover, automatically inserted context-related data links can be limited to linkable data only included on the disc 120, thereby providing a self-contained link-expanded account of a trip. In such a situation, a fact that the disc 120 includes encrypted additional linkable data content substantially unrelated to one or more images recorded by the user 20 on the disc 120 is irrelevant when the disc 120 has considerably more capacity than required to record the user's 20 images. The user 20 is thereby able to compile a library of several of the discs 120 customized to one or more venues visited by the user 20.

Although the camera apparatus 10, for example as depicted in FIG. 1, is described in the foregoing as being an integrated device, namely its parts being housed within its exterior protective casing, it is envisaged that it can be made potentially user-wearable by subdividing the apparatus 10 into a plurality of locally interconnected parts. Moreover, such interconnection is susceptible to being achieved by short-distance radio communication in a manner of a personally local wireless local area network. For example, the apparatus 10 is susceptible to being disposed in a plurality of user-wearable modules interconnected by miniature radio transceivers complying with the contemporary Blue Tooth standard; for example, the drive 100 is implementable as a pocket device or a belt-worn device.

In the foregoing, the drive 100 is described as an optical data storage device. However, the inventors envisage that other types of data storage devices can additionally or alternatively be employed, for example miniature magnetic hard disc and solid state memory.

In respect of the foregoing, and also with respect to the appended claims, expressions such as “comprise”, “include”, “incorporate”, “contain”, “is” and “have” are intended to be construed non-exclusively, namely allowing for other items or components which are not explicitly disclosed also to be present.

1. A method of automatically including one or more context related links in association with scene data content, characterized in that the method includes the steps of:
(a) providing a recording apparatus (10) including:
(i) data storing means (100) for reading and/or writing data content;
(ii) sensing means (70) for sensing audio and/or visual subject matter from a scene (FS) and generating corresponding scene data content;
(iii) identifying means (50, 60) for use in identifying a spatial location of the apparatus (10) in proximity of the scene (FS) and/or an identity of the scene (FS);
(iv) computing means (30) for coordinating operation of the data storing means (100), the sensing means (70) and the identifying means(50, 60);
(b) arranging for the data storing means (100) to include link data susceptible to being invoked to associate one or more spatial locations (FS) and/or scene identities with corresponding linkable data content;
(c) activating the apparatus (10) in proximity of a desired scene (FS) and receiving audio and/or visual subject matter therefrom to generate corresponding desired scene data content;
(d) using the identifying means (50, 60) to determine a spatial location of the apparatus (FS) in proximity of the desired scene and/or an identity of the desired scene (FS);
(e) identifying one or more links (410) in the link data associated with the spatial location and/or identity determined in step (d) and recording them automatically together in the storing means (100) with at least one of the desired scene data content derived from step (c) and the spatial location and/or identity from step (d),
wherein the one or more links are concurrently and/or subsequently susceptible to being invoked to include corresponding linkable data content with the scene data to generate final composite data content.

2. A method according to claim 1, wherein in step (d) the identifying means (50, 60) is arranged to determine the spatial location of the apparatus (10) in proximity of the desired scene and/or the identity of the desired scene by employing at least one of:
(i) a GPS satellite-derived reference (310);
(ii) an identification provided from one or more remotely communicating devices (320) included within the desired scene (FS), the devices (320) being arranged to impart information regarding the nature of the scene (FS) to the apparatus (10); and
(iii) by image and/or audio analysis of the desired scene data content by correlating and/or associating the desired scene data with scene-identification reference data.

3. A method according to claim 1, wherein the one or more links automatically included with the scene data content are susceptible to being at least one of:
(i) dormant and susceptible to being activated on subsequent user demand;
(ii) active at user demand and susceptible to being rendered dormant on subsequent user demand.

4. A method according to claim 3, wherein the one or more links automatically and/or on user demand included with the scene data content are susceptible to being subsequently deleted, for example when not required for generating the composite data.

5. A method according to claim 1, wherein at least one of the link data and its associated linkable data content are provided to the apparatus (10) in at least partly encrypted form, the apparatus (10) being operable to decrypt at least a part of the encrypted link data and its associated link data content using one or more decryption keys.

6. A method according to claim 5, wherein the one or more decryption keys are provided to the apparatus (10) in return for corresponding consideration, for example payment.

7. A method according to claim 1, wherein the data storing means is operable to receive the link data by at least one of:
(i) coupling the apparatus (10) to a communication network having available therein the link data; and
(ii) introducing a data carrier (120) to the storing means (100), the carrier including at least the link data recorded thereon.

8. A method according to claim 1, wherein the data storing means (100) comprises at least one of:
(a) one or more optical data carriers (110, 120);
(b) one or more magnetic hard disc data carriers; and
(c) one or more solid state memory devices,
for recording thereon of one or more of the link data, the linkable data content, the desired scene data and the composite data content.

9. A method according to claim 8, wherein the storing means (100) is disposed such that at least one of the data carriers (120) is externally accessible to the apparatus (10) for introducing at least one of the link data and the linkable data content to the apparatus.

10. A method according to claim 8, wherein the data carrier (120) is a small format optical data storage (SFFO) disc.

11. A method according to claim 1, wherein the link data includes at least one universal resource locator (URL) susceptible to being invoked to access linkable data content via a communication network, for example the Internet.

12. A method according to claim 1, wherein:
(i) the link data and its associated linkable data are provided to the apparatus (10) on an externally accessible first data carrier (120); and
(ii) the one or more links in the link data associated with the spatial location in step (e) together with the desired scene data content on an internally retained second data carrier (110).

13. A method according to claim 12, wherein the first data carrier is a vendor-supplied item whose link data and its associated linkable data content are at least partly in encrypted form and susceptible to being accessed by supplying one of more corresponding decryption keys to the apparatus, such decryption keys being obtainable for example in return for payment or other consideration.

14. A method according to claim 13, wherein the first data carrier includes encrypted link data and/or linkable data content which is encrypted in a plurality of degrees so that progressive access to the link data and/or linkable data content is achievable corresponding to progressive acquisition of decryption keys.

15. A method according to claim 1, wherein the linkable data content includes at least one of: supplementary pictures, movies, sound, text and web-sites.

16. An apparatus (10) operable to include automatically one or more context related links in association with scene data content, characterized in that the apparatus (10) includes:
(i) data storing means (100) for reading and/or writing data content;
(ii) sensing means (70) for sensing audio and/or visual subject matter from a scene (FS) and generating corresponding scene data content;
(iii) identifying means (50, 60) for use in identifying a spatial location of the apparatus (10) in proximity of the scene (FS) and/or an identity of the scene (FS);
(iv) computing means (30) for coordinating operation of the data storing means (100), the sensing means (70) and the identifying means (50, 60);
wherein:
(a) the data storing means (100) is arranged to include link data susceptible to being invoked to associate one or more spatial locations with corresponding linkable data content;
(b) the apparatus (10) is operable when in proximity of a desired scene (FS) to receive audio and/or visual subject matter therefrom to generate corresponding desired scene data content;
(c) the identifying means (50, 60) is operable to determine a spatial location of the apparatus (10) in proximity of the desired scene (FS) and/or the identity of the desired scene (FS);
(d) the computing means (30) is operable to identify one or more links in the link data associated with the spatial location (FS) and/or the identity of the desired scene (FS) determined by the identifying means (50, 60), and to record them automatically together in the storing means (100) with at least one of the desired scene data content derived from sensing means (70) and the spatial location and/or the identity derived from the identifying means (50, 60),
wherein the one or more links are concurrently and/or subsequently susceptible to being invoked to include corresponding linkable data content with the scene data to generate final composite data content.

17. Infrastructure (310, 320) for providing a position reference in proximity of the desired scene (FS) and/or an identification of the desired scene to the identifying means (50, 60) in the method according to claim 1.

18. Infrastructure (310, 320) for providing a position reference in proximity of the desired scene (FS) and/or an identification of the desired scene for use with the apparatus according to claim 16.
